(19) United States
(12) Patent Application Publication
(10) Pub. No.: US 2024/0302023 A1
(43) Pub. Date: Sep. 12, 2024

(54) MIRROR ASSEMBLY POWERING SYSTEM

(71) Applicant: Gentex Corporation, Zeeland, MI (US)

(72) Inventors: James P. Dratz, Zeeland, MI (US); Joshua T. Miles, Holland, MI (US); Brandon W. Watt, Byron Center, MI (US); Craig Kendall, Grand Haven, MI (US); Paul M. Andary, Holland, MI (US)

(73) Assignee: Gentex Corporation, Zeeland, MI (US)

(21) Appl. No.: 18/599,618

(22) Filed: Mar. 8, 2024

Related U.S. Application Data
(60) Provisional application No. 63/489,436, filed on Mar. 10, 2023.

(51) Int. Cl. F21S 45/60; F21S 43/20; F21V 23/00

(52) U.S. Cl. CPC F21S 45/60; F21V 23/001

(57) ABSTRACT

A mirror assembly for a vehicle includes a lighting module that is configured to illuminate through a section of the mirror assembly. An electro-optic assembly includes a front substrate having a first surface and a second surface opposite the first surface. A second substrate has a third surface and a fourth surface opposite the third surface. The second and third surfaces face each other to define a gap. A first electrode is coupled to the second surface, and a second electrode is coupled to the third surface. An electro-optic medium is located between the first electrode and the second electrode. A power hub is in electrical communication with and provides power to both the lighting module and the electro-optic assembly.

### CROSS-REFERENCE TO RELATED APPLICATION

This application claims priority to and the benefit under 35 U.S.C. § 119 (e) of U.S. Provisional Application No. 63/489,436, filed on Mar. 10, 2023, entitled “MIRROR ASSEMBLY POWERING SYSTEM,” the disclosure of which is hereby incorporated herein by reference in its entirety.

### FIELD OF THE DISCLOSURE

The present disclosure generally relates to a mirror assembly with a lighting module, and, more particularly, to a mirror assembly with a lighting module and one or more additional electrical components receiving power from a power hub shared with the lighting module.

### SUMMARY OF THE DISCLOSURE

According to one aspect of the present disclosure, a mirror assembly for a vehicle includes a lighting module that is configured to illuminate through a section of the mirror assembly. A heating assembly includes a heat generating conduction track. A printed circuit board (“PCB”) includes a first conductive trace that is electrically coupled with the lighting module and a second conductive trace that is electrically coupled with the heating assembly. A power hub is electrically coupled to the first and second conductive traces and provides power to both the lighting module and the heating assembly.

According to another aspect of the present disclosure, a mirror assembly for a vehicle includes a lighting module that is configured to illuminate through a section of the mirror assembly. An electro-optic assembly includes a front substrate having a first surface and a second surface opposite the first surface. A second substrate has a third surface and a fourth surface opposite the third surface. The second and third surfaces face each other to define a gap. A first electrode is coupled to the second surface, and a second electrode is coupled to the third surface. An electro-optic medium is located between the first electrode and the second electrode. A printed circuit board (“PCB”) includes a first conductive trace that is electrically coupled with the lighting module and a second conductive trace that is electrically coupled with the electro-optic assembly. A power hub is electrically coupled to the first and second conductive traces and provides power to both the lighting module and the electro-optic assembly.

According to yet another aspect of the present disclosure, a mirror assembly for a vehicle includes a lighting module that is configured to illuminate through a section of the mirror assembly. An electro-optic assembly includes a front substrate having a first surface and a second surface opposite the first surface. A second substrate has a third surface and a fourth surface opposite the third surface. The second and third surfaces face each other to define a gap. A first electrode is coupled to the second surface, and a second electrode is coupled to the third surface. An electro-optic medium is located between the first electrode and the second electrode. A heating assembly is configured to heat the mirror assembly. A printed circuit board (“PCB”) includes a first conductive trace that is electrically coupled with the lighting module, a second conductive trace that is electrically coupled with the electro-optic assembly, and a third conductive trace electrically coupled with the heating assembly. A power hub is electrically coupled to the first, second, and third conductive trace and provides power to each of the lighting modules, the electro-optic assembly, and the heating assembly.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top view of a vehicle with a mirror assembly in accordance with an aspect of the present disclosure;

FIG. 2A is a disassembled view of a mirror assembly of a first construction and a first arrangement in accordance with an aspect of the present disclosure;

FIG. 2B is an enlarged view of a PCB from FIG. 2A illustrating conductive traces on the PCB in accordance with an aspect of the present disclosure;

FIG. 3A is a disassembled view of a mirror assembly of a first construction and a second arrangement in accordance with an aspect of the present disclosure;

FIG. 3B is an enlarged view of a PCB from FIG. 3A illustrating conductive traces on the PCB in accordance with an aspect of the present disclosure;

FIG. 4A is a disassembled view of a mirror assembly of a first construction and a third arrangement in accordance with an aspect of the present disclosure;

FIG. 4B is an enlarged view of a PCB from FIG. 4A illustrating conductive traces on the PCB in accordance with an aspect of the present disclosure;

FIG. 5 is a cross-sectional and partial schematic view of a mirror assembly of a first construction and a third arrangement in accordance with an aspect of the present disclosure;

FIG. 6 is a front view of a mirror assembly of a second construction and a fourth arrangement in accordance with an aspect of the present disclosure;

FIG. 7 is a front view of a mirror assembly of a second construction and a fifth arrangement in accordance with an aspect of the present disclosure; and

FIG. 8 is a front view of a mirror assembly of a second construction and a sixth arrangement in accordance with an aspect of the present disclosure.

### DETAILED DESCRIPTION

The present illustrated embodiments reside primarily in combinations of method steps and apparatus components related to a mirror assembly with a lighting module and one or more additional electrical components receiving power from a power hub shared with the lighting module. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

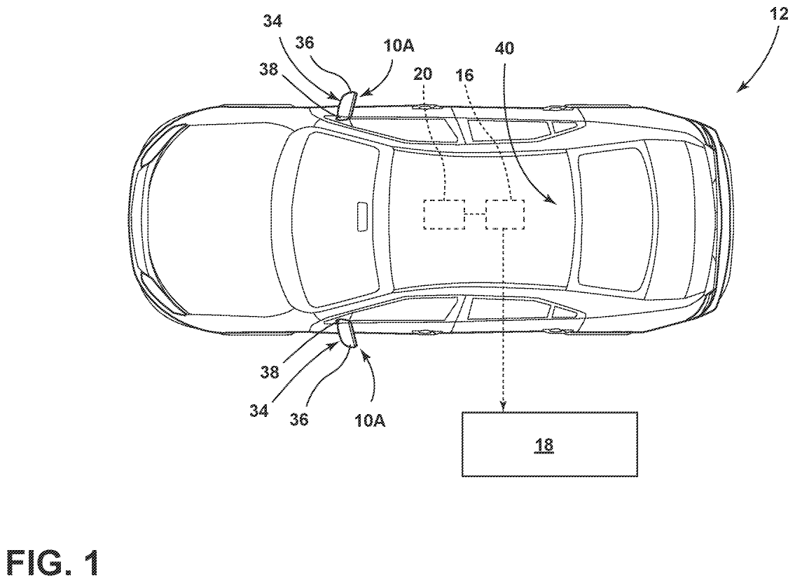

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

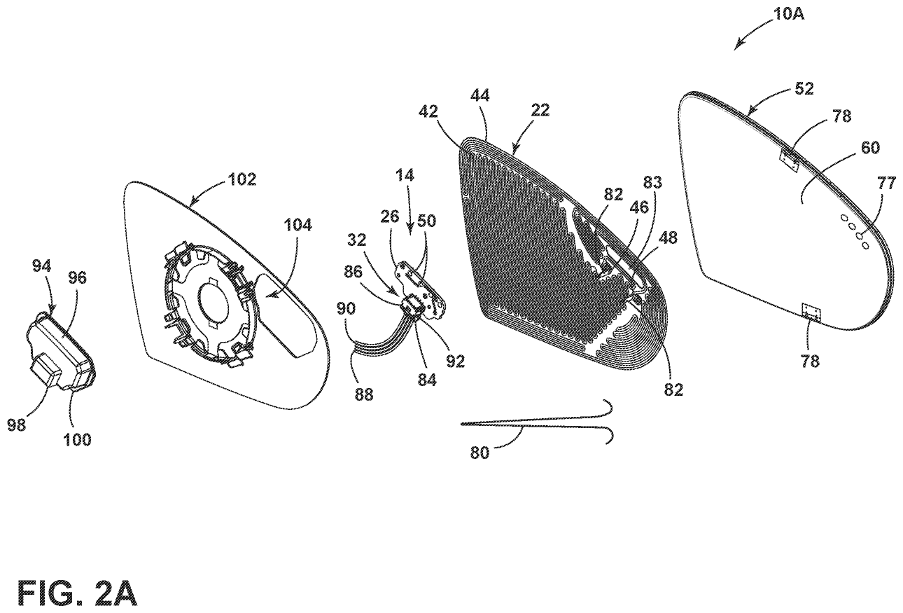

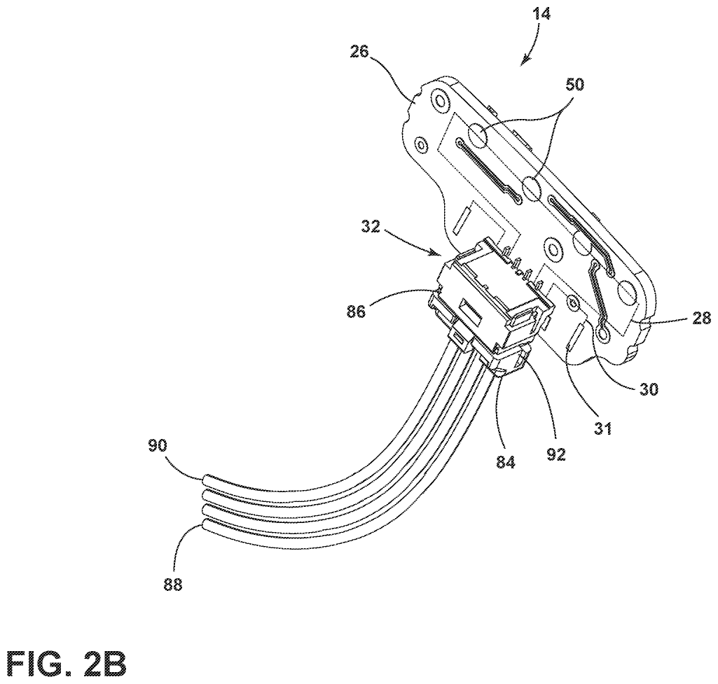

Referring to FIGS. 1-2B, reference numeral 10A generally designates a mirror assembly for a vehicle 12 in accordance with a first construction and a first arrangement. The mirror assembly 10A includes a lighting module 14 (FIGS. 2A and 2B) that is configured to illuminate through a section of the mirror assembly 10A. A heating assembly 22 includes conductive tracks 42 for generating heat. Alternatively, the heating assembly 22 may include heat generating material, for example, a positive temperature coefficient (“PTC”) material. In PTC material, heat is generated when current passes between a high and low voltage conductive heater trace 42. A printed circuit board 26 (“PCB”) includes a first conductive trace 28 electrically coupled with the lighting module 14 and a second conductive trace 30 electrically coupled with the heating assembly 22 (FIG. 2B). A power hub 32 is electrically coupled to the first and second conductive traces 28, 30 and provides power to both the lighting module 14 and the heating assembly 22. In some embodiments, each conductive trace 28, 30 includes a pair of conductive traces 28, 30 that provide a closed loop conduction path for the lighting module 14 and the heating assembly 22. In some embodiments, each conductive trace 28, 30 may include a single conductive trace 28, 30 that provides power to the lighting module 14 and the heating assembly 22 and a separate and shared return trace (e.g., a ground trace).

With reference back to FIG. 1, the mirror assembly 10A may be incorporated in various structures. For example, the mirror assembly 10A may be incorporated in a side mirror 34 (e.g., a pair of side mirrors 34) for connection to one or more sides of the vehicle 12. For example, the side mirror 34 may include a housing 36 and a mounting member 38 that connects the housing 36 to an exterior 40 (e.g., side) of the vehicle 12. However, generally speaking, the mirror assembly 10A may be incorporated into any other structure (e.g., an aircraft, water vessel, architecture, and/or the like) that includes a mirror or window with two or more of a heating system, an electro-optic component, and/or an accessory, such as a lighting module. The lighting module 14 is configured to illuminate through a section of the mirror assembly 10A. More particularly, the lighting module 14 may illuminate through the mirror assembly 10A to generate a visual notification of a driving or an environmental condition. In some embodiments, the lighting module 14 may be configured to relay a turn signal indicator (e.g., via flashing an illumination on whichever side mirror 34 is in a direction that the vehicle 12 will be turning). In some embodiments, the lighting module 14 may be configured to relay that an object has been detected in a blind spot. For example, a sensor 16 may be located in other locations around the vehicle 12 and configured to monitor locations around the vehicle 12 for the presence of an object 18. The sensor 16 may be electrically coupled to a communication module 20 (e.g., a wired or wireless connection) for generating a signal to the lighting module 14 to illuminate the section of the mirror assembly 10A when the presence of the object 18 is identified in a blind spot of the vehicle 12. In some embodiments, the lighting module 14 may be configured to illuminate portions of the vehicle 12 and/or surrounding environment under certain conditions. For example, the lighting module 14 may be oriented to illuminate the ground surrounding the vehicle 12 and function as a puddle light. In some embodiments, the lighting module 14 may include two or more of the above functions.

With reference now to FIGS. 2A and 2B, the heating assembly 22 includes a conduction track 42 (e.g., a conductive trace) that distributes heat along an area of the heating assembly 22. More particularly, the heating assembly 22 includes an outer perimeter 44 and the conduction track 42 extends along a path within the outer perimeter 44 that covers a substantial part (e.g., 35% or more, 40% or more, 50% or more, 75% or more, or 75% or less) of the area defined by the outer perimeter 44. The conduction track 42 extends between a first heating conduction terminal 46 and a second heating conduction terminal 48. The conduction track 42 may be a single track or may comprise multiple electrically conductive pathways. The first and second conductive traces 28, 30 (FIG. 2B) may each be electrically coupled to a different one of the first and second heating conduction terminals 46, 48 via direct contact or a conductive intermediary 31. The conductive intermediary 31 may include one or more of connection clips 82 (FIG. 2A), a conductive terminal, a different type of conductor, such as a wire, solder, compliant pin, conductive paste, conductive epoxy, conductive springs, conductive adhesive, and/or the like. The conductive intermediary 31 may be located in a via. In this manner, a full conduction loop (e.g., heating loop) formed along the conduction track 42 and extending between the PCB 26 and the second conductive trace 30. It should be appreciated that, unless otherwise expressly indicated, the mirror assembly 10A of the first construction and first arrangement may share all the same features, materials, and functions, and be incorporated into the same structures as the other constructions and arrangements described herein.

The lighting module 14 may include a plurality of light sources 50 electrically coupled to the first pair of conductive trace 28. The first conductive trace 28 (FIG. 2B) may be connected to each of the light sources 50 and form a full conduction loop that extends between the power hub 32 and the light source 50. In some embodiments, the first conductive trace 28 may be configured to control single, select groupings, or each of the light sources 50 independently. In some embodiments, the lighting module 14 includes an optical element, such as a lens, for focusing and directing light projected from the light sources 50 towards areas around the vehicle 12.

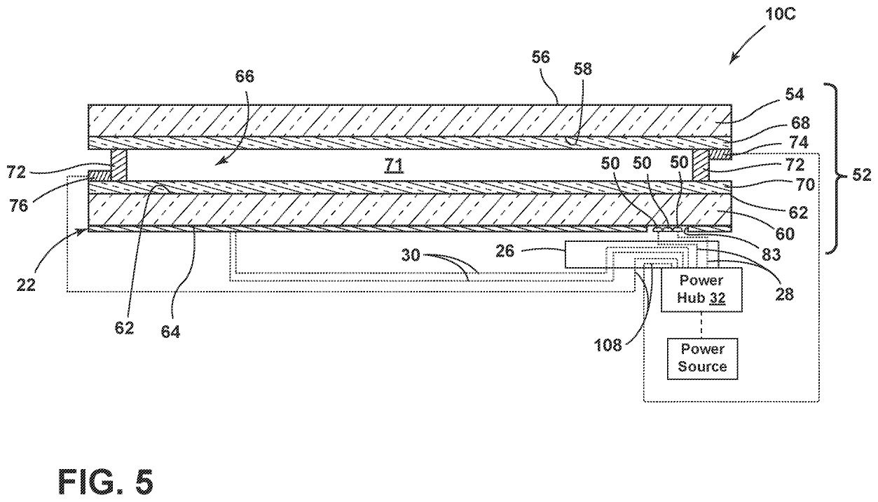

With reference now to FIGS. 2A and 5, the mirror assembly 10A may include a glass element, such as a substrate with a reflective surface or coating. In some embodiments, the glass element is configured as an electro-optic assembly 52 (e.g., an electrochromic assembly) that is heated by the heating assembly 22. The electro-optic assembly 52 may be switchable between various degrees of transmissiveness and/or reflectiveness (i.e., transflective). The electro-optic assembly 52 includes a front substrate 54 having a first surface 56 and a second surface 58 opposite the first surface 56. A second substrate 60 has a third surface 62 and a fourth surface 64 opposite the third surface 62. The second and third surfaces 58, 62 face each other to define a gap 66. A first electrode 68 is coupled to the second surface 58, and a second electrode 70 is coupled to the third surface 62. An electro-optic medium 71 (e.g., an electrochromic medium) is located between the first electrode 68 and the second electrode 70. In some embodiments, the front substrate 54 may define a front surface or viewing area of the mirror assembly 10A. In other embodiments, additional substrates (not shown) may be coupled to the front substrate 54 and define the viewing area. The electro-optic medium 71 may be retained within the gap 66 via a seal 72 that extends along a perimeter of the electro-optic assembly 52. A first electrical bus 74 may be connected to the first electrode 68, and a second electrical bus 76 may be connected to the second electrode 70. More particularly, the electrical buses 74, 76 may provide current to the electrodes 68, 70. The first electrical bus 74 and the second electrical bus 76 may each be connected to a conductive clip 78, for example, a metal that wraps around the perimeter edge and onto the fourth surface of the electro-optic assembly 52. The electro-optic assembly 52 in the first construction and the first arrangement of the mirror assembly 10A may not be connected through the PCB 26. More particularly, the electro-optic assembly 52 may be controlled via an independent electro-optic wire 80 (or other types of conductors) that are electrically coupled to the electrical buses 74, 76 (e.g., via the conductive clip 78) and routed through the mirror assembly 10A. For example, the independent electro-optic wires 80 may extend from the electro-optic assembly 52 and be routed through the housing 36 and the mounting member 38 of the side mirror 34. The light sources 50 are aligned with the electro-optic assembly 52 such that it illuminates therethrough. In some embodiments, a portion of the electro-optic assembly 52, such as the second electrode 70, may include apertures 77 that provide an optical path for illumination from the light sources 50 towards areas of interest and blocks the illumination in other areas that do not need to be illuminated. A concealment layer (not shown), such as an opaque ring or a chrome ring may be located between the seal 72 and the front substrate 54.

With reference now to FIGS. 2A and 2B, the first heating conduction terminal 46 and the second heating conduction terminal 48 of the heating assembly 22 may connect to the PCB 26 via heating connection clips 82, which may be configured as compliant pins that run through the PCB 26 or other types of contact pads, pins, contacts, wires, contact springs. The heating assembly 22 may define an aperture 83 located within the outer perimeter 44, and a component of the lighting module 14 is located on the PCB 26 and aligned with the aperture 83 to receive and/or transmit information therethrough. More particularly, the component may include the light sources 50 that are aligned with the aperture 83 and apertures 77. The power hub 32 may include a pair of lighting module connection inlets 84 and a pair of heating assembly connection inlets 86. A pair of lighting module wires 88 may connect to the lighting module connection inlets 84, and a pair of heating assembly wires 90 may connect to the heating assembly connection inlets 86. A wire harness 92 may be connected to the lighting module wires 88 and the heating assembly wires 90, and may function as an intermediary to electrically couple the lighting module wires 88 and the heating assembly wires 90 to the PCB 26, respectively.

With continued reference to FIGS. 2A and 2B, the mirror assembly 10A may include a cover 94 that covers the lighting module 14 and PCB 26. The cover 94 may include a body portion 96 that defines a pocket for locating the PCB 26 and lighting module 14 and a head portion 98 that defines a pocket for locating the wire harness 92. The cover 94 may seal and protect the PCB 26 and wire harness 92 (e.g., the power hub 32). For example, the body portion 96 may include a bottom edge 100 (e.g., that is flanged) that is sealed (e.g., hermetically) to the heating assembly 22 (e.g., around the aperture 83) with an adhesive. The mirror assembly 10A may further include a carrier plate 102 and the heating assembly 22 may be sandwiched between the carrier plate 102 and the electro-optic assembly 52. The carrier plate 102 may function to locate components of the mirror assembly 10A and connect the mirror assembly 10A to an integrated structure, such as the housing 36 of the side mirror 34. In some embodiments, the carrier plate 102 defines a PCB opening 104 that is aligned with the PCB 26 and cover 94. The cover 94 may extend at least partially through the PCB opening 104. In some embodiments, at least the body portion 96 of the cover 94 is transparent or semi-transparent to allow illumination from the lighting module 14 to pass therethrough.

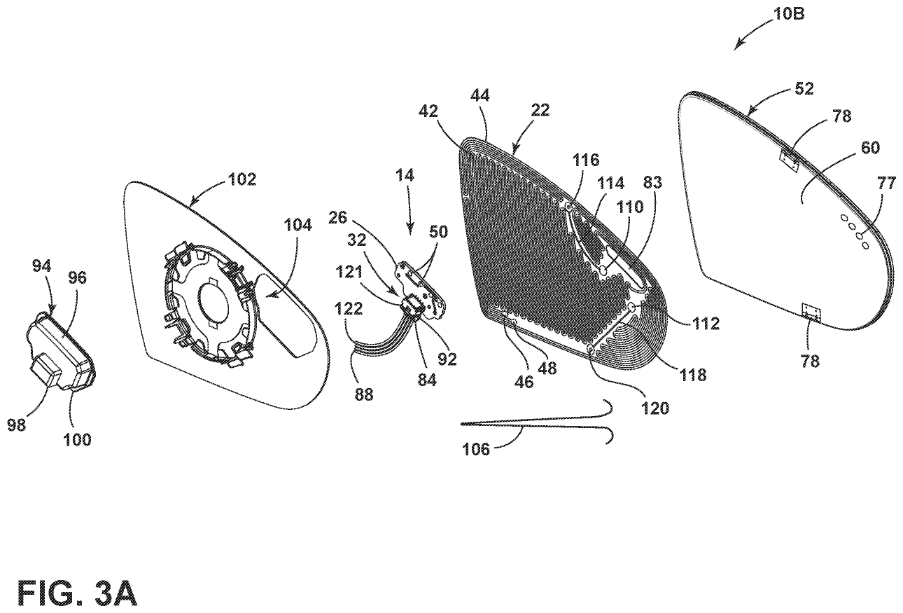

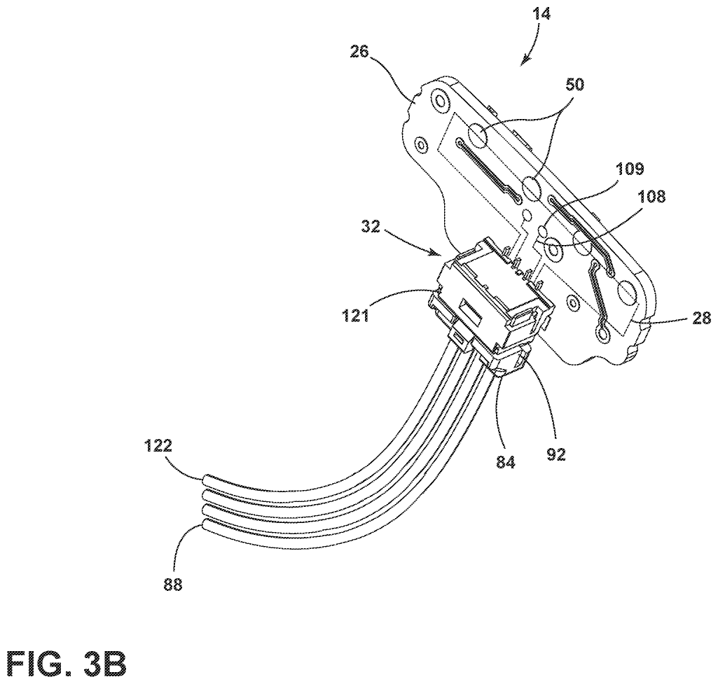

With reference now to FIGS. 3A and 3B, a mirror assembly 10B is illustrated in accordance with the first construction and second arrangement. Unless otherwise expressly indicated, the mirror assembly 10B of the first construction and second arrangement may share all the same features, materials, and functions, and be incorporated into the same structures as the other constructions and arrangements described herein. More particularly, in the second arrangement, the heating assembly 22 does not receive power directly from the PCB 26 and, instead, receives power from a pair of independent heating wires 106 (or other types of conductors) that circumvent the PCB 26 to provide power to the heating assembly 22. Instead, in the second arrangement, the electro-optic assembly 52 receives power from the PCB 26. More particularly, the PCB 26 may include a third conductive trace 108 (FIG. 3B) electrically coupled to the electro-optic assembly 52. The third conductive trace 108 may connect to a first electro-optic terminal 110 and a second electro-optic terminal 112 via direct contact or a conductive intermediary 109 (e.g., a conductive terminal, a different type of conductor, such as a wire, solder, compliant pin, conductive paste, conductive epoxy, conductive springs, conductive adhesive, and/or the like) that may be located in a via. The first electro-optic terminal 110 may be electrically coupled to a first electro-optic track 114 integrally or otherwise that extends between the first electro-optic terminal 110 to a first electro-optic conduction inlet 116. The second electro-optic terminal 112 may, likewise, be electrically coupled to a second electro-optic track 118 integrally or otherwise that extends between the second electro-optic terminal 112 to a second electro-optic conduction inlet 120. The first and second electro-optic terminals 110, 112 are electrically coupled to the power hub 32, and the first and second electro-optic tracks 114, 118 may extend from the terminals 110, 112 around the heating assembly 22 (e.g., around an outer perimeter 44, through the aperture 83, or through a different hole) to the first and second electro-optic conduction inlets 116, 120. The first and second electro-optic conduction inlets 116, 120 are electrically coupled to (e.g., soldered) a respective one of the conductive clips 78. For example, the first and second electro-optic tracks 114, 118 may extend around the outer perimeter 44, through the aperture 83, or through a different hole of the heating assembly 22 such that the first and second electro-optic conduction inlets 116, 120 contact the conductive clips 78 either directly or through a conductive intermediary (e.g., solder, a paste, ink, epoxy, tape, or solid conductor). In some embodiments, the first and second electro-optic tracks 114, 118 may extend to vias in the heating assembly 22 such that the first and second electro-optic conduction inlets 116, 120 contact the conductive clips 78 either directly (e.g., by extending through the via) or through a conductive intermediary (e.g., a paste, ink, tape, or solid conductor). The power hub 32 may include a pair of electro-optic connection inlets 121, and the wire harness 92 may be connected to the lighting module wires 88 and electro-optic power wires 122 and may function as an intermediary to electrically couple the lighting module wires 88 and the electro-optic power wires 122 to the PCB 26 (e.g., via inlets 84, 121). The heating assembly 22 in the first construction and the second arrangement of the mirror assembly 10B may not be connected through the PCB 26. More particularly, the heating assembly 22 may be controlled via the independent heating wires 106 that are electrically coupled to the conduction track 42 (e.g., the first and second heating conduction terminals 46, 48). In some embodiments, each conductive trace 28, 108 includes a pair of conductive traces 28, 108 that provide a closed loop conduction path for the lighting module 14 and electro-optic assembly 52. In some embodiments, each conductive trace 28, 108 may include a single conductive trace 28, 108 that provides power to the lighting module 14 and electro-optic assembly 52 and a separate and shared return trace.

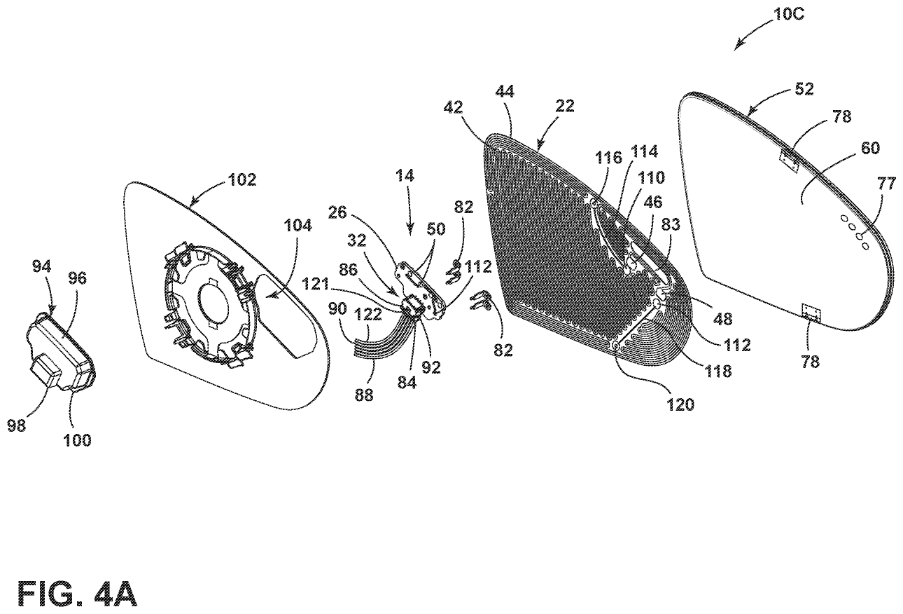

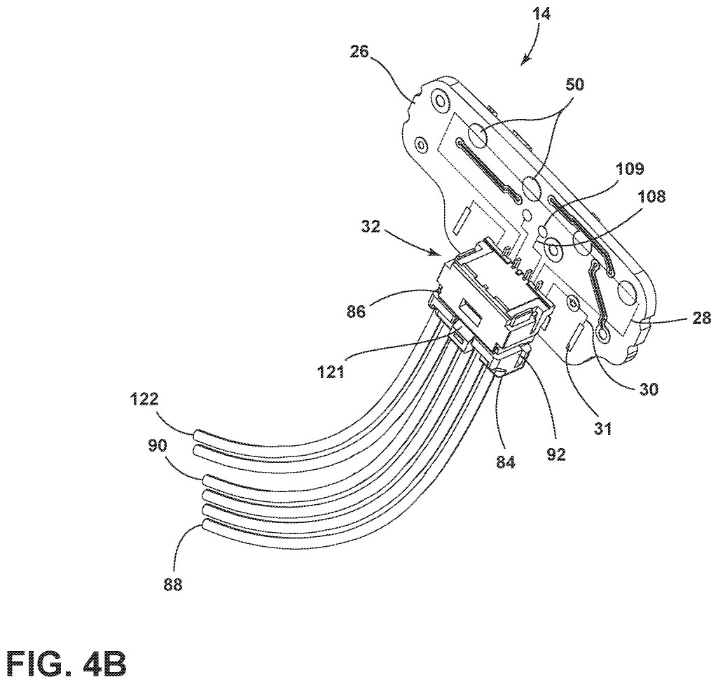

With reference now to FIGS. 4A-5, a mirror assembly 10C is illustrated in accordance with the first construction and third arrangement. Unless otherwise expressly indicated, the mirror assembly 10C of the first construction and the third arrangement may share all the same features, materials, and functions, and be incorporated into the same structures as the other constructions and arrangements described herein. More particularly, in the third arrangement, both the heating assembly 22 and the electro-optic assembly 52 receive power directly from the PCB 26. As such, the PCB 26 includes each of the pairs of conductive traces 28, 30, and 108 and the wire harness 92 is connected to the lighting module wires 88, the heating assembly wires 90, and the electro-optic power wires 122 and may function as an intermediary to electrically couple the lighting module wires 88, the heating assembly wires 90, and the electro-optic power wires 122 to the PCB 26. In some embodiments, each conductive trace 28, 30, and 108 includes at least one (e.g., a pair of) conductive traces 28, 30, and 108 that provide a closed loop conduction path for the lighting module 14, the heating assembly 22, and the electro-optic assembly 52. In some embodiments, the at least one conductive trace 28, 30, and 108 may provide power to the lighting module 14, the heating assembly 22, and/or the electro-optic assembly 52 and include a separate and shared return trace. In some embodiments, two of the conductive traces 28, 30, and 108 have a separate and shared return trace and the other of the conductive trace 28, 30, and 108 includes a pair with an independent closed loop path.

FIG. 5 illustrates a mirror assembly 10C of the first construction and a third arrangement. As will be described in greater detail below, each of the lighting module 14, the heating assembly 22, and the electro-optic assembly 52 receive power from the PCB 26 in the third arrangement. However, it should be appreciated that the mirror assembly 10C depicted in FIG. 5 may be utilized in the other constructions and arrangements, but without necessarily including connections between the PCB 26 and each of the lighting module 14, the heating assembly 22, and the electro-optic assembly 52. As such, it should be appreciated that the mirror assembly 10C depicted in FIG. 5 may be utilized in describing any of the other constructions and arrangements, but may additionally include, for example, the independent electro-optic wires 80 (FIG. 2A) or independent heating wires 106 (FIG. 3A) rather than direct connection through the PCB 26.

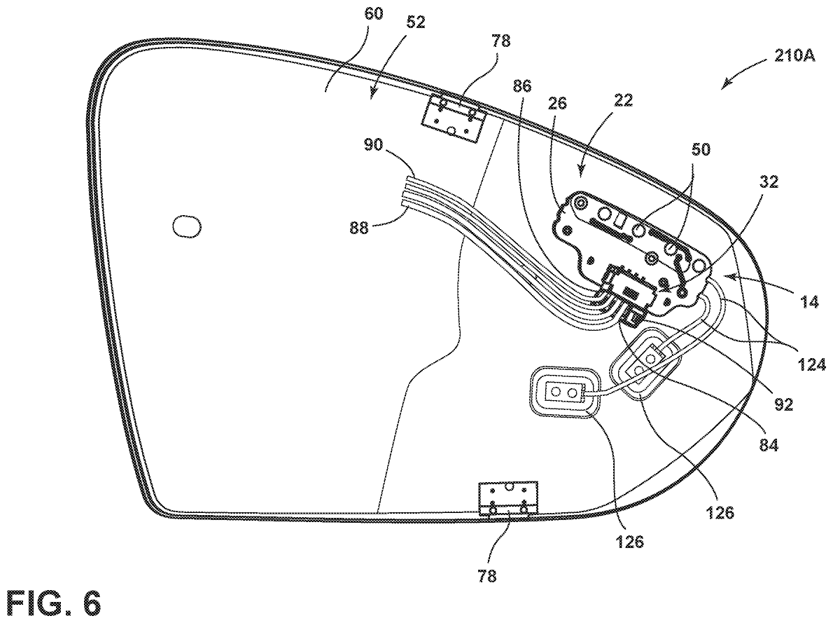

With reference now to FIG. 6, a mirror assembly 210A is illustrated in accordance with a second construction and a fourth arrangement. Unless otherwise expressly indicated, the mirror assembly 210A of the second construction and fourth arrangement may share all of the same features, materials, and functions, and be incorporated into the same structures as the other constructions and arrangements described herein. More particularly, the PCB 26 is electrically coupled to the lighting module 14 and the heating assembly 22. The connection with the heating assembly 22 is with means other than and/or additionally to the second conductive trace 30. For example, the PCB 26 may be electrically coupled to the heating assembly 22 with a heating intermediary wire 124. The heating intermediary wire 124 may include a pair of heating intermediary wires 124 that each extends between the PCB 26 (e.g., the second conductive trace 30) to a heating conduction paddle 126 that is electrically coupled with the heating assembly 22. In some embodiments, the heating assembly 22 (e.g., the conduction tracks 42) may be energized by the heating intermediary wires 124 from power hub 32 without inclusion of the conduction track 42. The paddles 126 may be at least partially conductive to distribute power along regions of the heating assembly 22 that are in contact with the paddles 126. While the heating assembly 22 is illustrated as only covering a region of one side of the electro-optic assembly 52, it should be appreciated that the heating assembly 22 may cover substantially an entire side of the electro-optic assembly 52 as illustrated in the first construction. The electro-optic assembly 52 in the second construction and the fourth arrangement of the mirror assembly 210A may not be connected through the PCB 26. More particularly, the electro-optic assembly 52 may be controlled via the independent electro-optic wires 80 (FIG. 2A) that are each electrically coupled to one of the electrical buses 74, 76 (e.g., via the conductive clip 78). In some embodiments, each conductive trace 28, 30 includes a pair of conductive traces 28, 30 that provide a closed loop conduction path for the lighting module 14 and the heating assembly 22. In some embodiments, each conductive trace 28, 30 may include a single conductive trace 28, 30 that provides power to the lighting module 14 and the heating assembly 22 and a separate and shared return trace.

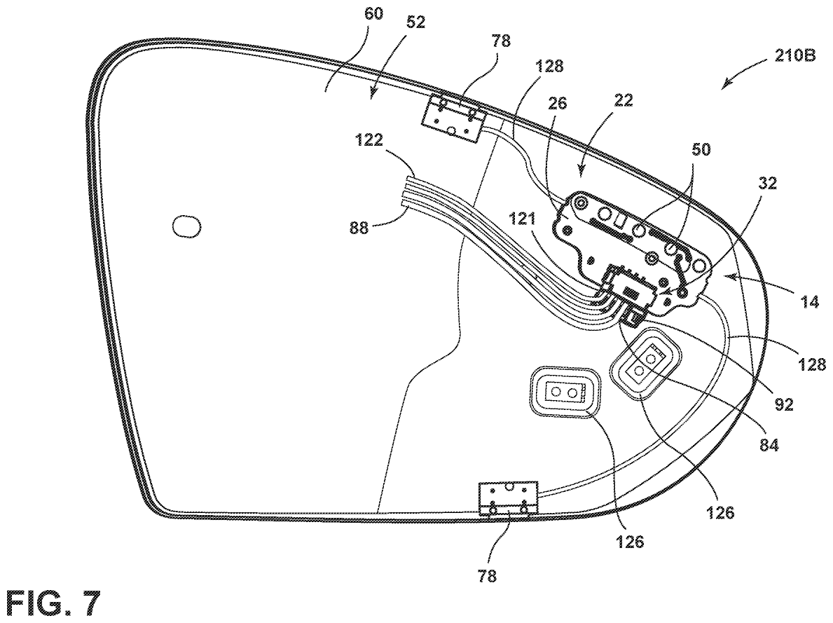

With reference now to FIG. 7, a mirror assembly 210B is illustrated in accordance with the second construction and a fifth arrangement. Unless otherwise expressly indicated, the mirror assembly 210A of the second construction and fifth arrangement may share all the same features, materials, and functions, and be incorporated into the same structures as the other constructions and arrangements described herein. More particularly, the PCB 26 is electrically coupled to the lighting module 14 and the electro-optic assembly 52. The connection with the electro-optic assembly 52 is with means other than and/or additionally to the third conductive trace 108. For example, the PCB 26 may be electrically coupled to the electro-optic assembly 52 with an electro-optic intermediary wire 128. The electro-optic intermediary wire 128 may include a pair of electro-optic intermediary wires 128 that each extends between the PCB 26 (e.g., the third conductive trace 108) to one of the conductive clips 78. The heating assembly 22 in the second construction and the fifth arrangement of the mirror assembly 210B may not be connected through the PCB 26. More particularly, the heating assembly 22 may be controlled via the independent heating wires 106 (FIG. 3A) that are electrically coupled to the paddles 126. In some embodiments, each conductive trace 28, 108 includes a pair of conductive traces 28, 108 that provide a closed loop conduction path for the lighting module 14 and electro-optic assembly 52. In some embodiments, each conductive trace 28, 108 may include a single conductive trace 28, 108 that provides power to the lighting module 14 and electro-optic assembly 52 and a separate and shared return trace.

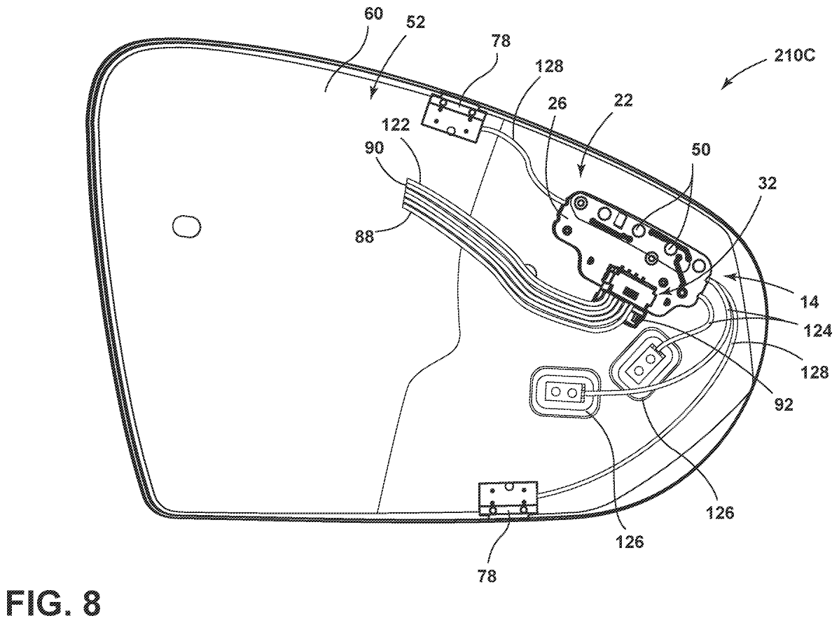

With reference now to FIG. 8, a mirror assembly 210C is illustrated in accordance with the second construction and sixth arrangement. Unless otherwise expressly indicated, the mirror assembly 210C of the second construction and the sixth arrangement may share all the same features, materials, and functions, and be incorporated into the same structures as the other constructions and arrangements described herein. More particularly, in the sixth arrangement, both the heating assembly 22 and the electro-optic assembly 52 receive power directly from the PCB 26. As such, the PCB 26 may be electrically coupled with the heating intermediary wires 124 and the electro-optic intermediary wires 128 (e.g., via the pairs of conductive traces 30 and 108) and the wire harness 92 is connected to the lighting module wires 88, the heating assembly wires 90, and the electro-optic power wires 122, and may function as an intermediary to electrically couple the lighting module wires 88, the heating assembly wires 90, and the electro-optic power wires 122 to the PCB 26. In some embodiments, each conductive trace 28, 30, and 108 may include a single conductive trace 28, 30, and 108 that provides power to the lighting module 14, the heating assembly 22, and the electro-optic assembly and a separate and shared return trace. In some embodiments, two of the conductive traces 28, 30, and 108 have a separate and shared return trace and the other of the conductive trace 28, 30, and 108 includes a pair with an independent closed loop path.

With reference now to FIGS. 1-8, the heating assembly 22 is depicted as a constant wattage heater. The heating assembly 22 may have two connections (e.g., from the power hub 32 or independently) and one or more pathways for current to run. Heat is generated by the resistance of the conduction track 42 (e.g., traces) and the current that flows as a result of the potential difference between the two connection points (typically called “terminals”). The conduction track 42 may be uniform in thickness, width, and spacing so that uniform heat is generated. The resistance of a constant wattage heater determines how much power will be generated at a given voltage. For example, the resistance of the heater may be 8 ohms, for example, at 13 V (when the vehicle 12 is running), and, as a result, the current may be about 1.6 A. The heating assembly 22 will generate about 21 Watts of power in this example. The performance of the heating assembly 22 is typically determined by how long it takes to heat the mirror assembly to clear the mirror of a given amount of ice, frost, or surface moisture. In some embodiments, it may be beneficial to provide uneven heating within certain portions of the mirror assembly 10A-10C and 210A-210C. For example, it may be beneficial to heat an outer perimeter (or other portion) more quickly or to a higher temperature. In such embodiments, more than two conduction tracks 42 may be utilized where a conduction track 42 around the portion of the mirror assemblies 10A-10C and 210A-210C that receives more heat may receive more power and/or be narrower in thickness and spacing to generate more heat. In other such embodiments, there is a single conduction track 42 and a portion of the conduction track 42 around the portion of the mirror assemblies 10A-10C and 210A-210C may be narrower in thickness and spacing to generate more heat.

With continued reference to FIGS. 1-8, as previously explained, it is contemplated that the heating assembly 22 may be configured as a PTC heater. In such embodiments, the conduction track 42 is configured as one or more electrical buses with traces split into multiple interdigitated pathways (e.g., a positive and a negative bus with positive and negative branches). For example, the conduction track 42 may look interdigitated like a pair of combs where the teeth are parallel to each other, but not touching. Unlike the constant wattage configuration, the PTC heater may include PTC material (e.g., a layer on a substrate) that generates heat and has a lower resistance at cold and room temperatures, but where the resistance increases significantly at higher temperatures. The result is that current flows from one trace at, for example, 13 V, through the PTC material, and then to the other trace at ground. Most of the heat is generated in the resistive PTC material. Once the PTC material is hot, the resistance of the PTC material increases, and as a result the current drops and the power of the heater drops with it. In embodiments that utilize the PTC heater configuration, it should be appreciated that the same connection schemes described in reference to the mirror assemblies 10A-10C and 210A-210C can be utilized. However, in such embodiments, the PTC material is conductive, and the higher voltage of the heater trace may damage the electro-optic assembly 52 because electro-optic assembly 52 is electrically coupled to the high voltage heating assembly 22. One solution to this problem would be to electrically isolate the electro-optic tracks 114, 118 from the heater trace. Electrical isolation will prevent unwanted communication between the heater traces and the electro-optic tracks 114, 118. The downside to electrical isolation is the area around the electro-optic tracks 114, 118 will not be heated.

With continued reference to FIGS. 1-8, it should further be appreciated that other types of heating assemblies may be utilized without departing from the scope of the subject application. It should also be appreciated that the mirror assemblies 10A-10C and 210A-210C may not include the electro-optic assembly 52, but instead include a glass element such as a single substrate with a reflective coating or an optical stack with a reflective coating other than the electro-optic assembly 52. In embodiments without the electro-optic assembly 52, the apertures 77 may be formed in a reflective coating the glass element.

It should be appreciated that the terms “first,” “second,” and “third” are provided for distinguishing between elements, such as the pairs of conductive traces 28, 30, and 108. These terms can be used interchangeably in the claims to simply distinguish between electrical components that connect to the lighting module 14, the heating assembly 22, and the electro-optic assembly 52 in order of recitation.

The disclosure herein is further summarized in the following paragraphs and is further characterized by combinations of any and all of the various aspects described therein.

According to one aspect of the present disclosure, a mirror assembly for a vehicle includes a lighting module that is configured to illuminate through a section of the mirror assembly. A heating assembly includes a heat generating conduction track. A printed circuit board (“PCB”) includes a first conductive trace electrically coupled with the lighting module and a second conductive trace electrically coupled with the heating assembly. A power hub is electrically coupled to the first and second conductive traces and provides power to both the lighting module and the heating assembly.

According to one aspect, a heating assembly is configured as a constant wattage heater.

According to another aspect, an electro-optic assembly comprises a front substrate that has a first surface and a second surface opposite the first surface. A second substrate has a third surface and a fourth surface opposite the third surface. The second and third surfaces face each other to define a gap. A first electrode is coupled to the second surface. A second electrode is coupled to the third surface. An electro-optic medium is located between the first electrode and the second electrode.

According to yet another aspect, a heating assembly is proximate to an electro-optic assembly to regulate a temperature to defrost or defog a front substrate.

According to still another aspect, a PCB includes a third conductive trace electrically coupled to an electro-optic assembly. The third conductive trace receives power from a power hub.

According to another aspect, a power hub includes a first connection to a first conductive trace, a second connection to a second conductive trace, and a third connection to a third conductive trace that provides power individually to a lighting module, a heating assembly, and an electro-optic assembly.

According to yet another aspect, an electro-optic assembly includes a pair of electric buses and at least one of the electric buses is connected to a conductive clip that is electrically coupled to a third conductive trace.

According to still another aspect, an electro-optic assembly receives power from a pair of independent electro-optic wires separate from a PCB.

According to yet another aspect, a pair of independent electro-optic wires each terminate at a different one of a pair of conductive clips coupled to a first and a second electrode.

According to still another aspect, a heating assembly defines an aperture and a component of a lighting module is located on a PCB and aligned with the aperture to receive or transmit information therethrough.

According to another aspect, a cover hermetically seals against the heating assembly.

According to yet another aspect, a heating assembly is electrically coupled to a second conductive trace with a compliant pin.

According to another aspect of the present disclosure, a mirror assembly for a vehicle includes a lighting module that is configured to illuminate through a section of the mirror assembly. An electro-optic assembly includes a front substrate having a first surface and a second surface opposite the first surface. A second substrate has a third surface and a fourth surface opposite the third surface. The second and third surfaces face each other to define a gap. A first electrode is coupled to the second surface, and a second electrode is coupled to the third surface. An electro-optic medium is located between the first electrode and the second electrode. A printed circuit board (“PCB”) includes a first conductive trace electrically coupled with the lighting module and a second conductive trace electrically coupled with the electro-optic assembly. A power hub is electrically coupled to the first and second conductive traces and provides power to both the lighting module and the electro-optic assembly.

According to yet another aspect, an electro-optic assembly is electrically coupled to a second conductive trace with a pair of conductive springs.

According to still another aspect, a heating assembly regulates a temperature to defrost or defog a front substrate.

According to yet another aspect, a PCB includes a third conductive trace electrically coupled to the heating assembly, the third conductive trace receiving power from a power hub.

According to still another aspect, a heating assembly receives power from a pair of independent heating wires separate from a PCB.

According to yet another aspect, each of a pair of independent heating wires terminate at one of a pair of paddles, respectively, each paddle in contact with a heating assembly.

According to yet another aspect of the present disclosure, a mirror assembly for a vehicle includes a lighting module that is configured to illuminate through a section of the mirror assembly. An electro-optic assembly includes a front substrate having a first surface and a second surface opposite the first surface. A second substrate has a third surface and a fourth surface opposite the third surface. The second and third surfaces face each other to define a gap. A first electrode is coupled to the second surface, and a second electrode is coupled to the third surface. An electro-optic medium is located between the first electrode and the second electrode. A heating assembly is configured to heat the mirror assembly. A printed circuit board (“PCB”) includes a first conductive trace electrically coupled with the lighting module, a second conductive trace electrically coupled with the electro-optic assembly, and a third conductive trace electrically coupled with the heating assembly. A power hub is electrically coupled to the first, second, and third conductive trace and provides power to each of the lighting module, the electro-optic assembly, and the heating assembly.

According to another aspect, an electro-optic assembly includes at least one aperture providing an optical path for an illumination from a lighting module.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A mirror assembly for a vehicle comprising:
a lighting module that is configured to illuminate through a section of the mirror assembly;
a heating assembly including a heat generating conduction track;
a printed circuit board (“PCB”) including a first conductive trace electrically coupled with the lighting module and a second conductive trace electrically coupled with the heating assembly; and
a power hub electrically coupled to the first and second conductive traces and providing power to both the lighting module and the heating assembly.

2. The mirror assembly of claim 1, wherein the heating assembly is configured as a constant wattage heater.

3. The mirror assembly of claim 1, further including an electro-optic assembly comprising:
a front substrate having a first surface and a second surface opposite the first surface;
a second substrate having a third surface and a fourth surface opposite the third surface, the second and third surfaces facing each other to define a gap;
a first electrode coupled to the second surface;
a second electrode coupled to the third surface; and
an electro-optic medium located between the first electrode and the second electrode.

4. The mirror assembly of claim 3, wherein the heating assembly is proximate to the electro-optic assembly to heat the mirror assembly.

5. The mirror assembly of claim 3, wherein the PCB includes a third conductive trace electrically coupled to the electro-optic assembly, the third conductive trace receiving power from the power hub.

6. The mirror assembly of claim 5, wherein the power hub includes a first connection to the first conductive trace, a second connection to the second conductive trace, and a third connection to the third conductive trace for providing power individually to the lighting module, the heating assembly, and the electro-optic assembly.

7. The mirror assembly of claim 5, wherein the electro-optic assembly further includes a pair of electric buses and at least one of the electric buses is connected to a conductive clip that is electrically coupled to the third conductive trace.

8. The mirror assembly of claim 3, wherein the electro-optic assembly receives power from a pair of independent electro-optic wires separate from the PCB.

9. The mirror assembly of claim 8, wherein the independent electro-optic wires each terminate at a different one of a pair of conductive clips coupled to the first and second electrodes.

10. The mirror assembly of claim 1, wherein the heating assembly defines an aperture and a component of the lighting module is located on the PCB and aligned with the aperture to receive or transmit information therethrough.

11. The mirror assembly of claim 1, further including a cover that hermetically seals against the heating assembly.

12. The mirror assembly of claim 1, wherein the heating assembly is electrically coupled to the second conductive trace with a compliant pin.

13. A mirror assembly for a vehicle comprising:
a lighting module that is configured to illuminate through a section of the mirror assembly;
an electro-optic assembly comprising:
a front substrate having a first surface and a second surface opposite the first surface;
a second substrate having a third surface and a fourth surface opposite the third surface, the second and third surfaces facing each other to define a gap;
a first electrode coupled to the second surface;
a second electrode coupled to the third surface; and
an electro-optic medium located between the first electrode and the second electrode;
a printed circuit board (“PCB”) including a first conductive trace electrically coupled with the lighting module and a second conductive trace electrically coupled with the electro-optic assembly; and
a power hub electrically coupled to the first and second conductive traces and providing power to both the lighting module and the electro-optic assembly.

14. The mirror assembly of claim 13, wherein the electro-optic assembly is electrically coupled to the second conductive trace with a pair of conductive springs.

15. The mirror assembly of claim 13, further including a heating assembly that regulates a temperature to defrost or defog the front substrate.

16. The mirror assembly of claim 15, wherein the PCB includes a third conductive trace electrically coupled to the heating assembly, the third conductive trace receiving power from the power hub.

17. The mirror assembly of claim 15, wherein the heating assembly receives power from a pair of independent heating wires separate from the PCB.

18. The mirror assembly of claim 17, wherein each of the independent heating wires terminate at one of a pair of paddles, respectively, each paddle in contact with the heating assembly.

19. A mirror assembly for a vehicle comprising:
a lighting module that is configured to illuminate through a section of the mirror assembly;
an electro-optic assembly comprising:
a front substrate having a first surface and a second surface opposite the first surface;
a second substrate having a third surface and a fourth surface opposite the third surface, the second and third surfaces facing each other to define a gap;
a first electrode coupled to the second surface;
a second electrode coupled to the third surface; and
an electro-optic medium located between the first electrode and the second electrode;
a heating assembly configured to heat the mirror assembly;
a printed circuit board (“PCB”) including a first conductive trace electrically coupled with the lighting module, a second conductive trace electrically coupled with the electro-optic assembly, and a third conductive trace electrically coupled with the heating assembly; and
a power hub electrically coupled to the first, second, and third conductive trace and providing power to each of the lighting module, the electro-optic assembly, and the heating assembly.

20. The mirror assembly of claim 19, wherein the electro-optic assembly includes at least one aperture providing an optical path for an illumination from the lighting module.
